(19) United States
(12) Patent Application Publication
(10) Pub. No.: US 2008/0189501 A1
(43) Pub. Date: Aug. 7, 2008

(54) Methods and Apparatus for Issuing Commands on a Bus

(76) Inventors: John D. Irish, Rochester, MN (US); Chad B. McBride, Rochester, MN (US)

Correspondence Address: IBM Corporation;Intellectual Property Law Dept. 917, 3605 Hwy. 52 North, Rochester, MN, 55901, US

(21) Appl. No.: 11/671,117

(22) Filed: Feb. 5, 2007

(51) Int. Cl. G06F 12/00

(52) U.S. Cl. 711/167; 711/E12.001

(57) ABSTRACT

In a first aspect, a first method of issuing a command on a bus of a system is provided. The first method includes the steps of (1) receiving a first functional memory command in the system; (2) receiving a command to force the system to execute functional memory commands in order; (3) receiving a second functional memory command in the system; and (4) employing a dependency matrix to indicate the second functional memory command requires access to a same address as the first functional memory command whether or not the second functional memory command actually has an ordering dependency on the first functional memory command. The dependency matrix is adapted to store data indicating whether a functional memory command received by the system has an ordering dependency on one or more functional memory commands previously received by the system. Numerous other aspects are provided.

### FIELD OF THE INVENTION

The present invention relates generally to processors, and more particularly to methods and apparatus for issuing commands on a bus.

### BACKGROUND

In a conventional system, a first processor may be coupled to a second processor by an input/output (I/O) interface. The first processor may receive commands, which are to be placed on a bus, from the second processor via the I/O interface. The first processor may split the received commands into a read command stream and a write command stream, store read commands in a read queue and store write commands in a write queue. The conventional system may maintain order between the command streams by determining whether a read command at the top of the read queue depends on completion of a pending write command and/or whether a write command at the top the write queue depends on completion of a pending read command. More specifically, the conventional system employs a read address collision list to track addresses associated with pending read commands and a write address collision list to track addresses associated with pending write commands.

The conventional system may maintain a first matrix indicating dependence of read commands on write commands. The first matrix may be populated by data output from the write address collision list when indexed by respective read commands. Similarly, the conventional system may maintain a second matrix indicating dependence of write commands on read commands. The second matrix may be populated by data output from the read address collision list when indexed by respective write commands. The conventional system may employ the dependency matrices and address collision lists to determine whether a command at the top of the read queue depends on a write command and/or whether a command at the top of the write queue depends on a read command.

Generally, a conventional system may operate in a mode in which commands in a queue may be issued on the bus and executed out of order. However, in some operational scenarios, a conventional system may force commands in the queue to be issued on the bus and executed in order. For example, a conventional system may employ a barrier command to force such in-order execution. For example, upon receiving the barrier command, the conventional system may employ complex manipulation of pointers to queue entries to force such in-order execution. Further, the conventional system may store the barrier command as an entry in the queue, thereby reducing the number of queue entries that may be used to store read or write commands. Further, the conventional system requires a large amount of logic to implement the complex pointer manipulation, which consumes additional space on a first processor and consumes chip real estate. Accordingly, improved methods and apparatus for issuing commands on a bus are desired.

### SUMMARY OF THE INVENTION

In a first aspect of the invention, a first method of issuing a command on a bus of a system is provided. The first method includes the steps of (1) receiving a first functional memory command in the system; (2) receiving a command to force the system to execute functional memory commands in order; (3) receiving a second functional memory command in the system; and (4) employing a dependency matrix to indicate the second functional memory command requires access to a same address as the first functional memory command whether or not the second functional memory command actually has an ordering dependency on the first functional memory command. The dependency matrix is adapted to store data indicating whether a functional memory command received by the system has an ordering dependency on one or more functional memory commands previously received by the system.

In a second aspect of the invention, a first apparatus for issuing a command is provided. The first apparatus includes (1) a bus; and (2) command pipeline logic coupled to the bus and including a dependency matrix adapted to store data indicating whether a functional memory command received by the command pipeline logic has an ordering dependency on one or more functional memory commands previously received by the command pipeline logic. The command pipeline logic is adapted to (a) receive a first functional memory command; (b) receive a command to force the command pipeline logic to execute functional memory commands in order; (c) receive a second functional memory command; and (d) employ the dependency matrix to indicate the second functional memory command requires access to the same address as the first functional memory command whether or not the second functional memory command actually requires access to a same memory address as the first functional memory command.

In a third aspect of the invention, a first system for issuing a command is provided. The first system includes (1) a first processor; and (2) a second processor coupled to the first processor and adapted to communicate with the first processor. The first processor includes an apparatus for issuing a command, comprising (a) a bus; and (b) command pipeline logic coupled to the bus and including a dependency matrix adapted to store data indicating whether a functional memory command received by the command pipeline logic has an ordering dependency on one or more functional memory commands previously received by the command pipeline logic. The apparatus is adapted to (i) receive a first functional memory command in the system; (ii) receive a command to force the system to execute functional memory commands in order; (iii) receive a second functional memory command in the system; and (iv) employ a dependency matrix to indicate the second functional memory command requires access to a same address as the first functional memory command whether or not the second functional memory command actually has an ordering dependency on the first functional memory command. Numerous other aspects are provided, as are systems and apparatus in accordance with these other aspects of the invention.

Other features and aspects of the present invention will become more fully apparent from the following detailed description, the appended claims and the accompanying drawings.

### BRIEF DESCRIPTION OF THE DRAWINGS

FIGS. 1A-B illustrate a block diagram of a system for issuing a command on a bus in accordance with an embodiment of the present invention.

FIG. 2 illustrates an exemplary dependency matrix that may be included in the system of FIGS. 1A-B in accordance with an embodiment of the present invention.

FIG. 3 illustrates dependency matrices that may be included in the system of FIGS. 1A-B and signals employed thereby in accordance with an embodiment of the present invention.

FIG. 4 illustrates details of command pipeline logic included in the system of FIGS. 1A-B in accordance with an embodiment of the present invention.

### DETAILED DESCRIPTION

The present invention provides improved methods and apparatus for issuing commands on a bus. Similar to a conventional system, the present system may split read and write commands into streams, store read commands in a read stream and store write commands in a write stream. Further, the present methods and apparatus may employ conventional read and write address collision lists and dependency matrices to determine whether a command at the top of a read queue depends on a write command and/or whether a command at the top of a write queue depends on a read command. Additionally, the present methods and apparatus may employ a barrier command, such as an “ensure in-order execution of I/O” (EIEIO) or sync command, to force in-order execution of commands stored in one or more of the queues. EIEIO and sync commands are known to a person of skill in the art, and therefore, are not described in detail herein.

In contrast to a conventional system, in some embodiments, the present methods and apparatus does not store the barrier command in a queue and/or does not rely on complex pointer manipulation to force in-order command execution. Therefore, the present methods and apparatus may more efficiently use queue entries and/or chip real estate. For example, assume the present system receives a read command which is followed by a barrier command which is followed by a write command. Upon receiving the read command, the present system may update the read address collision list with an address associated with the read command, and store the read command in the read queue. Upon receiving the barrier command, the present system may set a barrier flag. The barrier flag indicates that the system will rely on a pre-calculated dependency rather than the one or more of the address collision lists to determine whether a subsequently-received command may be issued on the bus. Such pre-calculated dependency may be stored in an address collision dependency matrix as a dummy address collision dependency. The pre-calculated dependency may cause the subsequently-received command to depend on the command received before the barrier command regardless of (e.g., whether or not there are) actual address collision dependencies. Therefore, upon receiving the write command following the barrier command, the system may employ the pre-calculated dependency to cause the write command to depend on the read command regardless of whether (e.g., whether or not) an address associated with the write command is different than that associated with the read command (and that associated with any other previously-received commands). The dependency of the write command may be cleared after the read command completes (e.g., is issued on the bus and executed). Thus, the system may force the read command to be executed before the write command. In this manner, the present invention provides improved methods and apparatus for issuing a command on a bus. For example, the present system may force in-order command execution without employing complex pointer manipulation and/or consuming a queue entry to store a barrier command employed to force the in-order command execution.

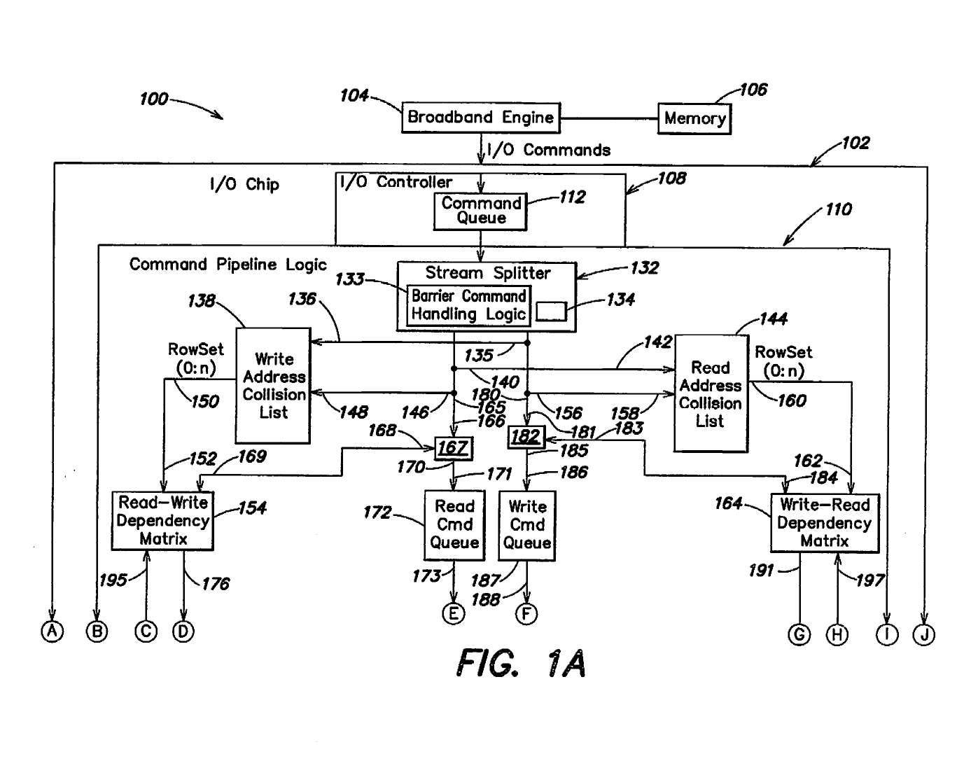

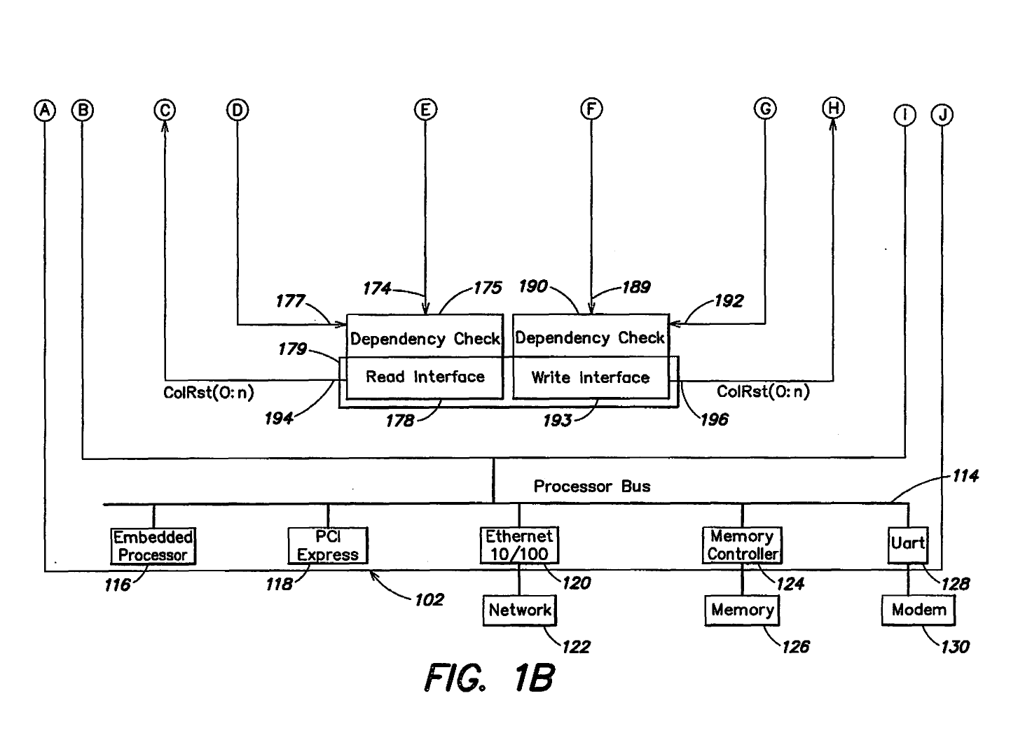

FIGS. 1A-B illustrate a block diagram of a system for issuing a command on a bus in accordance with an embodiment of the present invention. With reference to FIGS. 1A-B, the system 100 may include a first processor 102 coupled to a second processor 104, which may be coupled to a memory 106. The first processor 102 may be adapted to receive commands (e.g., read and/or write commands to an I/O subsystem) from the second processor 104. Additionally or alternatively, the first processor 102 may be adapted to receive a barrier or fence command (hereinafter “barrier command”). As described below, a barrier command may force in-order execution of received commands. More specifically, the barrier command may force a read or write command received before the barrier command to complete before a read or write command received after the barrier command may complete. The first processor 102 may be an input/output (I/O) processor and the second processor 104 may be a main processor or CPU 104 which issues commands to the first processor 102.

The first processor 102 may include an I/O controller 108 coupled to command pipeline logic 110 (e.g., bus master logic). The I/O controller 108 may be adapted to receive commands from the second processor 104 and transmit such commands to command pipeline logic 110. More specifically, the I/O controller 108 may include a command queue 112 adapted to store the commands received from the second processor 104 and issue commands to the command pipeline logic 110.

The command pipeline logic 110 may be coupled to a processor bus 114. The command pipeline logic 110 may be adapted to determine and track address collision dependencies of the commands (e.g., execution order dependencies) received thereby. Further, the command pipeline logic 110 may be adapted to create dummy address collisions dependencies for one or more received commands to force in-order execution of the commands (e.g., in response to receiving a barrier command). More specifically, the command pipeline logic 110 may be adapted to determine whether an address associated with (e.g., targeted by) a received command is the same as an address associated with a previously-received command. Further, the command pipeline logic 110 may be adapted to determine whether a barrier command is received, and if so, to make a command received after the barrier command depend from a command received before the barrier command. More specifically, the command pipeline logic 110 may create a dummy address collision dependency for the command received after the barrier command such that that command depends on the command received before the barrier command. The command pipeline logic 110 may be adapted to issue commands on the processor bus 114 based on address collision dependencies (e.g., actual and dummy address collision dependencies) of the commands, respectively. Additional details of the command pipeline logic 110 are described below.

The processor bus 114 may be coupled to one or more components and/or I/O device interfaces through which an address associated with a command may be accessed. For example, the processor bus 114 may be coupled to a processor 116 embedded in the first processor 102. Additionally, the processor bus 114 may be coupled to a PCI Express card 118 adapted to couple to a PCI bus (not shown). Further, the processor bus 114 may couple to a network card 120 (e.g., a 10/100 Mbps Ethernet card) through which the first processor 110 may access a network 122, such as a wide area network (WAN) or local area network (LAN). Additionally, the processor bus 114 may couple to a memory controller (e.g., a Double Data Rate (DDR2) memory controller) 124 through which the first processor 110 may couple to a second memory 126. Also, the processor bus 114 may couple to a Universal Asynchronous Receiver Transmitter (UART) 128 through which the first processor 110 may couple to a modem 130. The above connections to the processor bus 114 are exemplary. Therefore, the processor bus 114 may couple to a larger or smaller amount of components or I/O device interfaces. Further, the processor bus 114 may couple to different types of components and/or I/O device interfaces. As described below the command pipeline logic 110 may efficiently issue and execute commands (e.g., in order) on the processor bus 114 which may require access to a component and/or I/O device interface coupled to the processor bus 114.

The command pipeline logic 110 may include stream splitter logic 132 adapted to separate commands received by the first processor 102 into a stream of read commands and a stream of write commands. The stream splitter logic 132 may assign respective read tags to received read commands and respective write tags to received write commands. Further, the stream splitter logic 132 may include barrier command handling logic 133 adapted to pre-calculate dependence (e.g., a dummy dependency) of one or more received commands on other commands. For example, the barrier command handling logic 133 may generate one or more vectors indicating dependence of a received command on one or more other commands received by the command pipeline logic 110. For example, such vectors may serve as a dummy address collision dependency on the first read or write command prior to the barrier instruction that prevents commands subsequent to the barrier from passing the command received before the barrier instruction.

The barrier command handling logic 133 may include at least one configuration register 134 adapted to indicate the type of dependencies pre-calculated by the command pipeline logic 110 for the received command. For example, the configuration register 134 may store a value indicating whether the barrier command handling logic 133 may pre-calculate a dependency of a received command on one or more other received commands, and if so, whether the barrier command handling logic 133 may pre-calculate the dependency of the received command on only commands of the same type as the received command, on only commands of a different type than the received command, or on commands of the same or different type than the received command. For example, if the configuration register 134 stores a logic “00”, the barrier command handling logic 133 may not pre-calculate a dependency of the received command on other commands. Further, if the configuration register 134 stores a logic “01”, the barrier command handling logic 133 may pre-calculate a dependency of a received read command on one or more other received read commands and a dependency of a received write command on one or more other received write commands. Additionally, if the configuration register 134 stores a logic “10”, the barrier command handling logic 133 may pre-calculate a dependency for a received read command on one or more received write commands and a dependency for a received write command on one or more received read commands. Further, if the configuration register 134 store a logic “11”, the barrier command handling 133 may pre-calculate a dependency for a received write command on one or more read commands and one or more other received write commands, and a dependency for a received read command on one or more write commands and one or more other received read commands. The above values are exemplary, and therefore, the barrier command handling logic 133 may calculate the above-described dependencies based on different configuration register values, respectively.

A first output 135 of the stream splitter logic 132 may be coupled to a first input 136 of a write address collision list 138. The write address collision list 138 may be similar to a contents-addressable memory (CAM) adapted to output data based on input data. The first input 136 of the write address collision list 138 may be employed to input entries for write commands and respective addresses associated therewith. In this manner, the write address collision list 138 may include entries corresponding to each received write command that is assigned a write tag.

Similarly, a second output 140 of the stream splitter logic 132 may be coupled to a first input 142 of a read address collision list 144. The read address collision list 144 may also be similar to a CAM adapted to output data based on input data. The first input 142 of the read address collision list 144 may be employed to input entries for read commands and respective addresses associated therewith. In this manner, the read address collision list 144 may include entries corresponding to each received read command that is assigned a read tag.

Further, a third output 146 of the stream splitter logic 132 may be coupled to a second input 148 of the write address collision list 138 such that an address associated with a read command may be input by the write address collision list 138. Based on such input, the write address collision list 138 may output one or more bits via a first output 150 thereof, which may be coupled to a first input 152 of a read-write dependency matrix 154. The bits may be stored as a row in the read-write dependency matrix 154 (e.g., in response to a row set command RowSet(0:n) by the command pipeline logic 110). Rows of the read-write dependency matrix 154 correspond to respective read tags that may be assigned to read commands. Columns of the read-write dependency matrix 154 correspond to respective write tags that may be assigned to write commands. Thus, each column may correspond to a write command and indicate read commands that depend on the write command.

A fourth output 156 of the stream splitter logic 132 may be coupled to a second input 158 of the read address collision list 144 such that an address associated with a write command may be input by the read address collision list 144. Based on such input, the read address collision list 144 may output one or more bits via a first output 160 thereof, which may be coupled to a first input 162 of a write-read dependency matrix 164. In this manner, the bits may be stored as a row in the write-read dependency matrix 164 (e.g., in response to a row set command RowSet(0:n) by the command pipeline logic 110). Rows of the write-read dependency matrix 164 correspond to respective write tags that may be assigned to write commands. Columns of the write-read dependency matrix 164 correspond to respective read tags that may be assigned to read commands. Thus, each column may correspond to a read command and indicate write commands that depend on the read command.

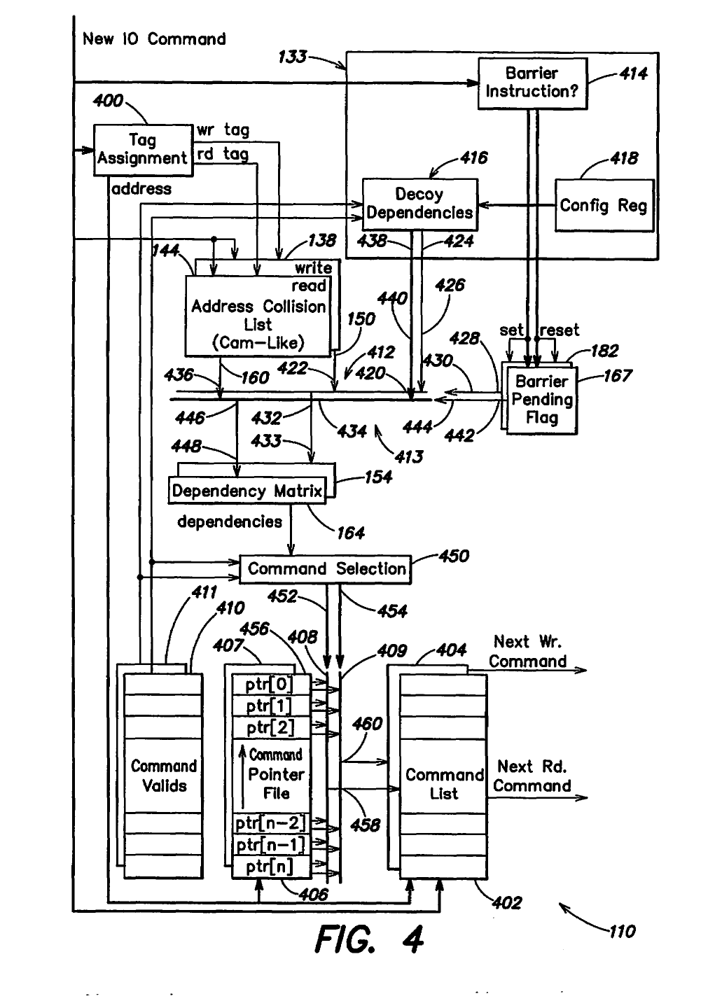

Additionally, a fifth output 165 of the stream splitter logic 132 may be coupled to an input 166 of read command control logic 167. The read command control logic 167 may be adapted to store one or more bits (e.g., a flag) indicating whether the command pipeline logic 110 has received a barrier command, which may cause the system 100 to execute a command received before and a command received after the barrier command in order. The barrier command handling logic 133 sets the flag upon receiving a barrier command. A first output 168 of the read command control logic 167 may be coupled to a second input 169 of the read-write dependency matrix 154. For a received command, data received via the write address collision list 138 or the read command control logic 167 may be input by the read-write dependency matrix 154. More specifically, the write address collision list 138 and the read command control logic 167 may be coupled to the read-write dependency matrix 154 via first selection logic (not shown in FIG. 1 for convenience; 412 in FIG. 4) adapted to selectively output data received from the write address collision list 138 or the read command control logic 167.

Further, a second output 170 of the read command control logic 170 may be coupled to an input 171 of a queue 172 adapted to store the read commands. A read command may pass through the read command control logic 167 and be stored in the read command queue 172. An output 173 of the read command queue 172 may be coupled to a first input 174 of first dependency check logic 175. Further, a first output 176 of the read-write dependency matrix 154 may be coupled to a second input 177 of the first dependency check logic 175. The first dependency check logic 175 may be adapted to determine whether dependencies associated with a received read command have cleared. More specifically, the first dependency check logic 175 may receive (e.g., via the second input 177 thereof) one or more bits of information indicating dependence of one or more read commands on one or more write commands from the read-write dependency matrix 154 output from the first output 176 thereof. Based on such bits, the first dependency check logic 175 may determine whether dependencies associated with respective commands in the read queue have cleared. The first dependency check logic 175 may be coupled to a read interface 178 which forms a first portion of a bus interface 179 through which commands are issued to the bus 114.

Similarly, a sixth output 180 of the stream splitter logic 132 may be coupled to an input 181 of write command control logic 182. The write command control logic 182 may be adapted to store one or more bits (e.g., a flag) indicating whether the command pipeline logic 110 has received a barrier command, which may cause the system 100 to execute a command received before and a command received after the barrier command in order. The barrier command handling logic 133 sets the flag upon receiving a barrier command. A first output 183 of the write command control logic 182 may be coupled to a second input 184 of the write-read dependency matrix 164. For a received command, data received via the read address collision list 144 or the read command control logic 182 may be input by the write-read dependency matrix 164. More specifically, the read address collision list 144 and the write command control logic 182 may be coupled to the write-read dependency matrix 164 via second selection logic (not shown in FIG. 1 for convenience; 413 in FIG. 4) adapted to selectively output data received from the read address collision list 144 or the write command control logic 182. The second selection logic 413 may be similar to the first selection logic 412.

Further, a second output 185 of the write command control logic 182 may be coupled to an input 186 of a queue 187 adapted to store the write commands. A write command may pass through the write command control logic 182 and be stored in the write command queue 187. An output 188 of the write command queue 187 may be coupled to a first input 189 of second dependency check logic 190. Further, a first output 191 of the write-read dependency matrix 164 may be coupled to a second input 192 of the second dependency check logic 190. The second dependency check logic 190 may be adapted to determine whether dependencies associated with a received write command have cleared. More specifically, the second dependency check logic 190 may receive (e.g., via the second input 192 thereof) one or more bits of information indicating dependence of one or more write commands on read commands from the write-read dependency matrix 164 via the first output 191 thereof. Based on such bits, the second dependency check logic 190 may determine whether dependencies associated with respective commands in the write command queue 187 have cleared. The second dependency check logic 190 may be coupled to a write interface 193 which forms a second portion of the bus interface 179.

The command pipeline logic 110 may be adapted to select a command from the read command queue 172 based on actual and/or dummy address collision dependencies of the commands on other commands. For example, once a command that is not dependent on other commands is selected from the read command queue 172, such command may be provided to the read interface 178. The read interface 178 may update one or more of the dependency matrices 154, 164 to update dependence of commands stored therein on the selected read command (e.g., via a column reset command ColRst(0:n) that updates bits associated with a write command indicating dependence of read commands thereon). For example, the column reset command may be output from the read interface 178 via a first output 194 thereof and input by a second input 195 of the read-write dependency matrix 154.

Similarly, the command pipeline logic 110 may be adapted to select a command from the write command queue 187 based on actual and/or dummy address collision dependencies of the commands on other commands. For example, once a command that is not dependent on other commands is selected from the write command queue 187, such command may be provided to the write interface 193. The write interface 193 may update one or more of the dependency matrices 154, 164 the write-read dependency matrix 164 to update dependence of commands stored therein on the selected write command (e.g., via a column reset ColRst(0:n) command that updates bits associated with a read command indicating dependence of write commands thereon). For example, the column reset command may be output from the write interface 193 via a first output 196 thereof and input by a second input 197 of the write-read dependency matrix 164. In some embodiments, the bus interface 179 may serve as an interface through which commands may be issued on the bus 114.

Thus, the present invention may provide an I/O processor 102 which may receive read, write, ensure in-order execution of I/O (EIEIO), sync and/or similar commands from another processor (e.g., CPU) via an I/O interface. The I/O processor 102 may buffer the commands and place the commands on a bus 114 (e.g., a processor bus) from which the commands may be passed along to an appropriate device (e.g., PCI-express interface card or DDR2 memory controller). For example, to prevent unnecessary stalls or delays of the write commands while waiting for read commands to complete, the I/O processor may split received commands into separate read and write streams. Because commands are separated in this manner, command order should be maintained between the streams. Depending on interfaces involved and a command target address, the ordering rules may range from strict to relaxed. Strict ordering states that the read and write commands must complete in the same order that they are issued from the CPU. Relaxed ordering states that read and write commands can pass each other if they are not targeting the same address space. However, another ordering rule may be employed. The ordering rule is passed along with the command as the command flows from the CPU. Ordering between the read and write streams may be maintained using one or more barrier commands, barrier command handling logic 133, a dependency matrix 154, 164 for each stream and an address look-up list to calculate dependencies. Read commands may maintain order between themselves due to the nature of the read command queue. Thus, for read commands, dependency information on other types of in-flight commands (e.g., write commands) is maintained. However, in some embodiments, the system 100 may include a read-read dependency matrix to maintain order between read commands. Similarly, write commands may maintain order between themselves due to the nature of the write command queue. Thus, for write commands, dependency information on other types of in-flight commands (e.g., read commands) is maintained. However, in some embodiments, the system 100 may include a write-write dependency matrix to maintain order between write commands. As read and write commands reach the top of their respective queue, a dependency check is performed to see if there are any outstanding dependencies. If there are dependencies, then the command and its respective queue may be stalled until the dependency is cleared.

For example, assume the present system receives a read command which is followed by a barrier command which is followed by a write command. Upon receiving the read command, the present system 100 may update the read address collision list 144 with an address associated with the read command, and store the read command in the read command queue 172. Upon receiving the barrier command, the barrier command handling logic 133 may set a barrier flag in the read command control logic 167 and/or the write command control logic 182. Upon receiving the write command, the barrier command handling logic 133 may pre-calculate a dependency of the write command. Such dependency may indicate the write command received after the barrier command depends on the read command received before the barrier command. The barrier flag indicates that the system 100 will rely on the pre-calculated dependency rather than one or more of the address collision lists 138, 144 to determine whether the command received after the barrier command (e.g., the write command) may be issued on the bus 114. Such pre-calculated dependency associated with the command received after the barrier command may be stored in one or more of the dependency matrices 154, 164 as a dummy address collision dependency. Thus, the pre-calculated dependency may cause the subsequently-received command (e.g., write command) to depend on the command (e.g., read command) received before the barrier command regardless of actual address collision dependencies. Therefore, upon receiving the write command, the system 100 may employ the pre-calculated dependency to cause the write command to depend on the read command regardless of whether an address associated with the write command is different than the address associated with the read command (and addresses associated with any other previously-received read commands).

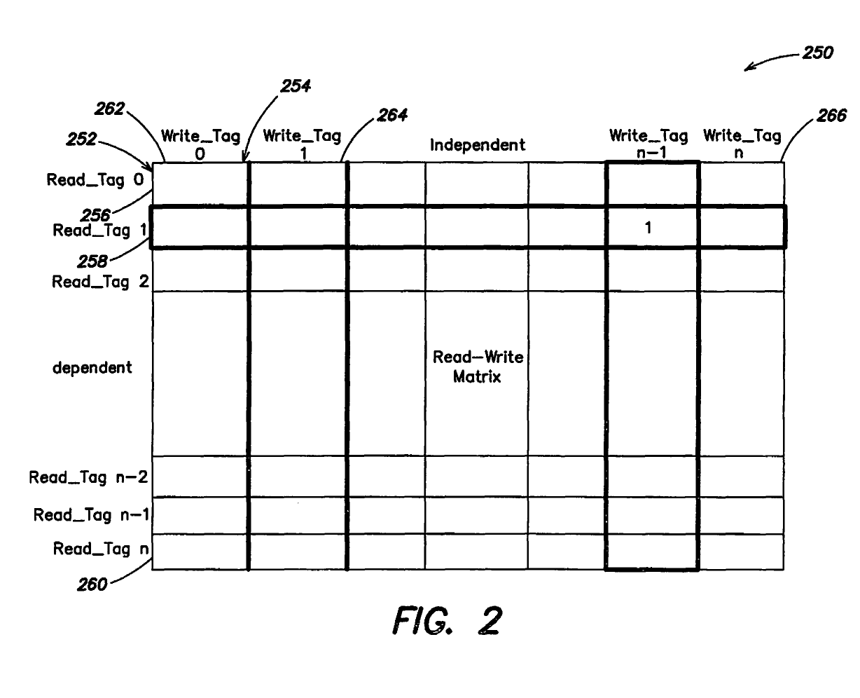

FIG. 2 illustrates an exemplary dependency matrix 250 that may be included in the system 100 of FIGS. 1A-B in accordance with an embodiment of the present invention. With reference to FIG. 2, the exemplary dependency matrix 250 may be the read-write dependency matrix (154 in FIGS. 1A-B) of the system 100. The dependency matrix 250 may be arranged into rows 252 and columns 254. Rows 252 of the dependency matrix 250 may correspond to read tags that may be assigned to a command in the command pipeline logic 110. For example, assuming the command pipeline logic 110 may assign n tags to read commands, a first row 256 of the dependency matrix 250 may correspond to the command assigned Read_Tag 0, a second row 258 of the dependency matrix 250 may correspond to the command assigned Read_Tag 1, and so on, such that the (n-1)th row 260 of the dependency matrix 250 may be assigned Read_Tag n.

Similarly, columns 254 of the dependency matrix 250 may correspond to write tags the may be assigned to commands in the command pipeline logic 100. For example, a first column 262 of the dependency matrix 250 may correspond to the command assigned Write_Tag 0, a second column 264 of the dependency matrix 250 may correspond to the command assigned Write_Tag 1, and so on, such that the (n-1)th column 266 of the dependency matrix 250 may be assigned Write_Tag n. The rows 252 may represent dependent values and the columns 254 may represent independent values. In this manner, bits stored in a row corresponding to a read tag assigned to a command may indicate that command's dependence on one or more commands assigned write tags (e.g., on one or more columns). For example, the asserted bit (e.g., logic “1”) in the second row 258 indicates the command assigned Read_Tag 1 depends on the command assigned Write_Tag n-1. Therefore, the command assigned Read_Tag 1 may not be issued on the bus (114 in FIGS. 1A-B) until the command assigned Write_Tag n-1 is issued on the processor bus 114 and completes. Remaining dependency matrices (164 in FIGS. 1A-B) of the system 100 may be arranged into rows and columns in a similar manner. Therefore, for the write-read dependency matrix 164, rows 252 correspond to write tags and columns 254 correspond to read tags.

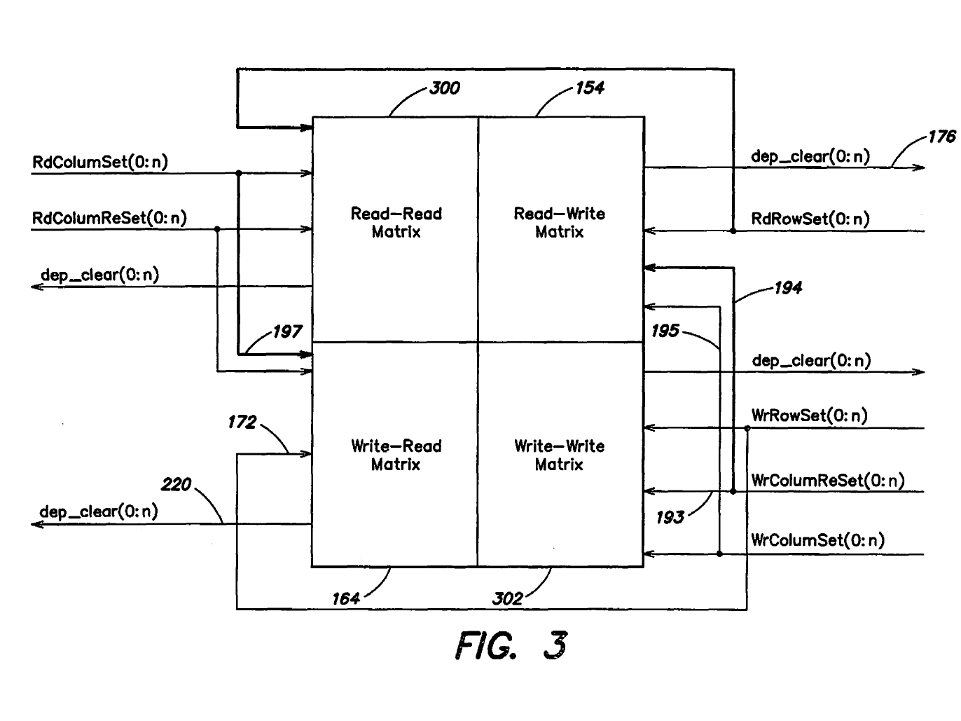

FIG. 3 illustrates dependency matrices that may be included in the system 100 of FIGS. 1A-B and signals employed thereby in accordance with an embodiment of the present invention. With reference to FIG. 3, in addition to the read-write dependency matrix 154 and the write-read dependency matrix 164, assume the system 100 include a read-read dependency matrix 300 and a write-write dependency matrix 302. The read-read dependency matrix 300 may be coupled to read address collision list 144, the first dependency check logic 175 and the read interface 178. More specifically, the read-read dependency matrix 300 may receive input from the read address collision list 144 and the read interface 178 like the write-read dependency matrix 164. Further, the read-read dependency matrix 300 may output data to the first dependency check logic 175 like the read-write matrix 154. The write-write dependency matrix 302 may be coupled to the write address collision list 138, the second dependency check logic 190 and the write interface 193. More specifically, the write-write dependency matrix 302 may receive input from the write address collision list 138 and the write interface 193 like the read-write dependency matrix 154. Further, the write-write dependency matrix 302 may output data to the second dependency check logic 190 like the write-read matrix 164.

Details of signals input by and output from the dependency matrices 154, 164, 300, 302 of the system 100 are illustrated. For example, data may be stored in a row 252 of the read-write dependency matrix 154 by a read row set command RdRowSet(0:n) issued by the write address collision list 138 or the read command control logic 167 and received by the read-write dependency matrix 154 via the first selection logic 412. In this manner, the read-write dependency matrix 154 may be updated to include information about read commands that depend on write commands because they are associated with the same address or appear to be associated with the same address (e.g., actual or dummy address collision dependency information). Such data may be output from the read command control logic 167 or from the write address collision list 138 in response to a lookup. Dependencies of read commands on a write command may be updated in the read-write matrix 154 by a write column set command WrColumSet(0:n) received by the matrix 154 (e.g., via the read command control logic 167). For example, assume the system 100 receives a new write command to be issued before one or more read commands previously-received by the system 100. The command pipeline logic 110 may employ the write column set command to update dependencies of such read commands stored by the matrix 154 to depend on the newly-received write command. Dependencies of read commands on a write command which has completed may be updated in the read-write matrix 154 by a write column reset WrColumReSet(0:n) input by the second input 194 of the matrix 154. In this manner, when a write command completes, read commands which have an actual or dummy address collision dependency on the write command are updated so the read commands no longer depend therefrom. The read-write dependency matrix 154 may output data dep_clear(0:n) about dependency of one or more read commands on write commands via the first output 176. Such data may be provided to the first dependency check logic 175, which may select a read command to be issued on the processor bus 114 based on the data.

Similarly, data may be stored in a row 252 of the write-write dependency matrix 302 by a write row set command WrRowSet(0:n) issued by the write address collision list 138 or the write command control logic 182 and received by the matrix 302 via the selection logic similar to the first selection logic 412. In this manner, the write-write dependency matrix 302 may be updated to include information about write commands that depend on write commands because they are associated with the same address or appear to be associated with the same address (e.g., real or dummy address collision dependency information). Such data may be output from the write command control logic 182 or the write address collision list 138 in response to a lookup. Dependencies of write commands on another write command may be updated in the write-write dependency matrix 302 by a write column set command WrColumSet(0:n) received by the dependency matrix 302 (e.g., via the write command control logic 182). For example, assume the system 100 receives a new write command to be issued before one or more write commands previously-received by the system 100. The command pipeline logic 110 may employ the write column set command to update dependencies of such previously-received write commands stored by the matrix 164 on the newly-received write command. Dependencies of write commands on another write command which has completed may be updated in the write-write dependency matrix 302 by a write column reset command WrColumReSet(0:n) input by the write interface 193 to the dependency matrix 302. In this manner, when a write command completes, write commands which have a dependency on the completing write command are updated such that the write commands no longer depend therefrom. The write-write dependency matrix 302 may output data dep_clear(0:n) about dependency of one or more write commands on other write commands to the second dependency check logic 190, which may select a write command to be issued on the processor bus 114 based on the data.

Similarly, data may be stored in a row 252 of the write-read dependency matrix 164 by a write row set command WrRowSet(0:n) issued by the read address collision list 144 or the write command control logic 182 and received by the dependency matrix 164 via the second selection logic 413. In this manner, the write-read dependency matrix 164 may be updated to include information about write commands that depend on read commands because they are associated with the same address or appear to be associated with the same address (e.g., real or dummy address collision dependency information). Such data may be output from the write command control logic 182 or from the read address collision list 144 in response to a lookup. Dependencies of write commands on a read command may be updated in the write-read matrix 164 by a read column set command RdColumSet(0:n) received by the dependency matrix 164 (e.g., via the write command control logic 182). For example, assume the system 100 receives a new read command to be issued before one or more write commands previously-received by the system 100. The command pipeline logic 110 may employ the read column set command to update dependencies of such write commands stored by the dependency matrix 154 to depend on the newly-received read command. Dependencies of write commands on a read command which completes may be updated in the write-read dependency matrix 164 by a read column reset command RdColumReSet(0:n) input by the third input 197 of the dependency matrix 164. In this manner, when a read command completes, write commands which have a dependency on the read command are updated so the write commands no longer depend therefrom. The write-read dependency matrix 164 may output data dep_clear(0:n) about dependency of one or more write commands on read commands via the first output 191. Such data may be provided to the second dependency check logic 190, which may select a write command to be issued on the processor bus 114 based on the data.

Similarly, data may be stored in a row 252 of the read-read dependency matrix 300 by a read row set command RdRowSet(0:n) issued by the read address collision list 144 or the read command control logic 167 and received by the dependency matrix 302 via selection logic similar to the first selection logic 412. In this manner, the read-read dependency matrix 300 may be updated to include information about read commands that depend on read commands because they are associated with the same address or appear to be associated with the same address (e.g., real or dummy address collision dependency information). Such data may be output from the read command control logic 167 or from the read address collision list 144 in response to a lookup. Dependencies of one or more read commands on a new read command may be updated in the read-read dependency matrix 300 by a read column set command RdColumSet(0:n) received by the dependency matrix 300 (e.g., via the read command control logic 167). Dependencies of one or more read commands on a read command which completes may be updated in the read-read dependency matrix 300 by a read column reset command RdColumReSet(0:n) received from the read interface 178 of the matrix 300. In this manner, when a read command completes, read commands which have a dependency on the completing read command are updated such that the read commands no longer depend therefrom. The read-read dependency matrix 300 may output data dep_clear(0:n) about dependency of read commands to the first dependency check logic 175, which may select a read command to be issued on the processor bus 114 based on the data. The above-described signals are exemplary, and therefore, a larger or smaller number of and/or different signals may be employed.

FIG. 4 illustrates details of command pipeline logic 110 included in the system 100 of FIGS. 1A-B in accordance with an embodiment of the present invention. With reference to FIG. 4, the command pipeline logic 110 may receive a new I/O command associated with an address. Tag assignment logic 400, which may be included in and/or coupled to the stream splitter logic 132, may receive the new command. The tag assignment logic 400 may be adapted to associate a read tag with each read command and a write tag with each write command received by the tag assignment logic 400.

The command pipeline logic 110 may include command buffers 402, 404 adapted to store read and write commands received by the logic 110, respectively. If the command pipeline logic 110 may associate n read tags with read commands and n write tags with write commands, the command buffers 402, 404 may each include n entries (although a larger or smaller number of entries may be employed). Additionally, for each command buffer 402, 404, the command pipeline logic 110 may include a queue (e.g., first in, first out (FIFO) queue) of command pointers 406, 407 coupled thereto. The queue of pointers 406, 407 may be adapted to track the structure of the command buffer 402, 404 (e.g., a first and last entry thereof). The queues of pointers 406, 407 may maintain command order for those commands that have ordering requirements and to manage entries in the command buffer list, respectively. A read queue of pointers 406 may be coupled to the read command buffer 402 via a first multiplexer 408 and the write queue of pointers 407 may be coupled to the write command buffer 404 via a second multiplexer 409. Each new command and tag associated therewith may be provided to the corresponding command buffer 402, 404 and/or queue of pointers 406, 407 so such command may be stored in the command buffer 402, 404. Further, the command pipeline logic 110 may include command valid queues 410, 411 corresponding to the read and write command buffers 402, 404 and the queues of pointers 406, 407, respectively. Entries in a first command valid queue 410 may correspond (e.g., with a 1:1 correspondence) to entries in the read command buffer 402 and a first queue of pointers 406. Each entry of the first command valid queue 410 may indicate whether a command stored by the corresponding entry of the read command buffer 402 is valid. Similarly, entries in a second command valid queue 411 may correspond (e.g., with a 1:1 correspondence) to entries in the write command buffer 404 and a second queue of pointers 407. Each entry of the second command valid queue 411 may indicate whether a command stored by the corresponding entry of the write command buffer 404 is valid.

As shown, each new command associated with an address along with a tag associated with the command may be provided to the read address collision list 144 and write address collision list 138. In this manner, the read address collision list 144 may be updated with newly-received read commands and addresses associated therewith, and the write address collision list 138 may be updated with newly-received write commands and addresses associated therewith as described above with reference to FIGS. 1A-B. Further, a read address collision list lookup and write address collision list lookup may be performed for each new command associated with an address and a tag. Data resulting from the write address collision list lookup may be output from the write address collision list 138 and input by the first selection logic 412. Similarly, data resulting from the read address collision list lookup may be output from the read address collision list 144 and input by the second selection logic 413.

Further, each new command received by the system 100 may be provided to the barrier command handling logic 133. The barrier command handling logic 133 may include first logic 414 adapted to determine whether the new command is a barrier command that may prevent a command received after the barrier command from being executed before a command received before the barrier command. If the first logic 414 determines the new command is a barrier command, the barrier command handling logic 133 may set (e.g., assert) a flag in the read and/or write command control logic 167, 182. In this manner, when a barrier instruction enters the I/O sub-system, a flag may be set which indicates that pre-calculated dependencies may be employed for the next load (e.g., read) and/or the next store (e.g., write) instructions respectively. Alternatively, if the first logic 414 determines the new command is not a barrier command (e.g., is a read or write command), the barrier command handling logic 133 may reset (e.g., deassert) the flag in the read and/or write command control logic 167, 182.

Further, the barrier command handling logic 133 may include second logic 416 adapted to pre-calculate a dependency of a new command on other commands. The second logic 416 may be coupled to the command valid queues 410, 411 and may determine valid pending functional memory commands stored in the command queues 402, 404 based on the command valid queues 410, 411. Based on such valid commands, the second logic 416 may generate one or more bits (e.g., a dependency vector) indicating dependency of the new functional memory command received after a barrier command on one or more valid functional memory commands (e.g., independent commands) received before the barrier command. There is a 1:1 mapping between the bit locations in the dependency vector and location in the command queue 402, 404 of the independent commands. Such bits may be similar to bits stored in a row of a dependency matrix 154, 164. The second logic 416 may be coupled to or include one or more configuration registers 418 or similar storage devices. For example, a register 418 may store a value indicating whether the second logic 416 pre-calculates dependency of a received command on one or more other received commands, and if so, whether the second logic 416 may pre-calculate the dependency of the received command on only commands of the same type as the received command, on only commands of a different type than the received command, or on commands of the same or a different type than the received command. In this manner, the configuration register 418 may cause the system 100 to pre-calculate dependencies of a new command based on full read, full write, or full read-write dependencies. For example, the register 418 may store a value indicating that the second logic 416 may pre-calculate a dependency of a received read command on write commands and a dependency of received write command on read commands.

Along with the write and read address collision lists 138, 144, the read command control logic 167, write command control logic 182 and barrier command handling logic 133 may be coupled to the first and/or second selection logic 412, 413. The first selection logic 412 may include a multiplexer 420 or similar device adapted to selectively output data. More specifically, the first output 150 of the write address collision list 138 may be coupled to a first input 422 of the first selection logic 412. Further, a first output 424 of the second logic 416 may couple to a second input 426 of the first selection logic 412. An output 428 of the write command control logic 182 may be coupled to a third input 430 (e.g., a control input) of the multiplexer 420 adapted to cause the first selection logic 412 to selectively output data input by the first or second input 422, 426 of the first selection logic 412 via an output 432 thereof. The output 432 of the first selection logic 412 may be coupled to an input 433 of the read-write dependency matrix 154. For example, during operation, the first selection logic 420 may input data output from the write address collision list 138 which indicates write commands on which a newly-received read command depends to the first selection logic 412. Further, the first selection logic 420 may input dummy dependency data output from the second logic 416. The dummy dependency data may indicate that the newly-received functional memory command may depend on the previously-received functional memory command. Additionally, the first selection logic 420 may input a control signal via the third input 430 indicating whether the command received before the new command was a barrier command. Based on such control signal, the first selection logic 420 may output the actual address collision data received from the write address collision list 138 or the dummy dependency data received from the second logic 416. For example, if the command received before the new command was not a barrier command, the first selection logic 420 may output the actual address collision data therefrom. Alternatively, if the command received before the new command was a barrier command, the first selection logic 420 may output the dummy dependency data therefrom.

The data output from the first selection logic 412 may be input by the read-write dependency matrix 154 and may serve as a row thereof which indicates dependence of the newly-received read command on one or more write commands due to an address collision. Thus, if the dummy dependency data is input by the read-write dependency matrix 154, such data may serve to indicate a dummy address collision between a new read command received after a barrier command and a write command received before the read command. Therefore, the new read command may not be issued on the bus and executed until the write command is issued on the bus and executed.

Similarly, the second selection logic 413 may include a multiplexer 434 or similar device adapted to selectively output data. More specifically, the first output 160 of the read address collision list 144 may be coupled to a first input 436 of the second selection logic 413. Further, a second output 438 of the second logic 416 may couple to a second input 440 of the second selection logic 413. An output 442 of the read command control logic 167 may be coupled to a third input 444 (e.g., a control input) of the multiplexer 434 adapted to cause the second selection logic 413 to selectively output data input by the first or second input 436, 440 of the second selection logic 413 via an output 446 thereof. The output 446 of the second selection logic 413 may be coupled to an input 448 of the write-read dependency matrix 164.

For example, during operation, the second selection logic 413 may input data output from the read address collision list 144 which indicates read commands on which a newly-received write command depends to the second selection logic 413. Further, the second selection logic 413 may input dummy dependency data output from the second output 438 of the second logic 416. The dummy dependency data may indicate that the newly-received functional memory command may depend on the previously-received functional memory command. Additionally, the second selection logic 413 may input a control signal via the third input 444 indicating whether the command received before the new command was a barrier command. Based on such control signal, the second selection logic 413 may output the actual address collision data received from the read address collision list 144 or the dummy dependency data. For example, if the command received before the new command was not a barrier command, the second selection logic 413 may output the actual address collision data therefrom. In this manner, the dependency matrices 154, 164 may be populated with real or dummy address collision data corresponding to a received command as described above with reference to FIGS. 1A-B. Alternatively, if the command received before the new command was a barrier command, the second selection logic 413 may output the dummy dependency data therefrom.

The data output from the second selection logic 413 may be input by the write-read dependency matrix 164 and may serve as a row thereof which indicates dependence of the newly-received write command on one or more read commands due to an address collision. Thus, if the dummy dependency data is input by the write-read dependency matrix 164, such data may serve to indicate a dummy address collision between a new write command received after a barrier command and a read command received before the write command. Therefore, the new write command may not be issued on the bus and executed until the read command is issued on the bus and executed.

Further, the dependency matrices 154, 164 may be coupled to command selection logic 450, one or more portions of which may be included in and/or coupled to the dependency check logic 175, 190. The command selection logic 450 may receive data about dependencies (e.g., real or dummy address collision dependencies) of a read command on write commands and/or other read commands. Further, the command selection logic 450 may receive data about dependencies of a write command on read commands and/or other write commands. Additionally, the command selection logic 450 may receive data about validity of functional memory commands from one or more of the command valid queues 410, 411. A first output 452 of the command selection logic 450 may be coupled to the first multiplexer 408 and a second output 454 of the command selection logic 450 may be coupled to the second multiplexer 409. Based on the dependency and validity of pending functional commands, the command selection logic 450 may output a signal that serves as a control signal for the first or second multiplexer 408, 409, which determines a pointer 456 from the queue of pointers 406, 407 that may be output from the multiplexer 408, 409 via an output 458, 460 thereof. The pointer 456 output from the multiplexer 408, 409 may serve as the head pointer of the command buffer 402, 404 which identifies the next read or write command to be output from the command buffer 402, 404 onto the bus (114 in FIGS. 1A-B). In this manner, the control signal may serve to shift the pointers every time a command is sent out onto the bus 114.

Exemplary operation of the system 100 for issuing a command on a processor bus 114 is now described with reference to FIGS. 1-4. The first processor 102 may receive one or more commands (e.g., I/O commands) from the second processor 104. Each command may be associated with (e.g., target or require access to) an address. Each command may be received in the I/O controller 108 and stored in the command queue 112. From the command queue 112, the command may be provided to the stream splitter logic 132. If the new command is a read command, the stream splitter logic 132 may channel the command to the read command queue 172. Alternatively, if the new command is a write command, the stream splitter logic 132 may channel the command to the write command queue 187. The stream splitter logic 132 may assign a tag to the new command based on tag availability. The stream splitter logic 132 may employ numerical priority with zero being the highest to assign a tag to the command. For example, assume the new command is a read command and the command pipeline logic 110 employs sixteen read tags Read_Tag 0—Read_Tag 15. If Read_Tag 0 and Read_Tag 1 are used and remaining read tags are free, the stream splitter logic 132 may assign the Read_Tag 2 to the new read command. However, the stream splitter logic 132 may assign tags in a different manner.

The command pipeline logic 110 may determine whether the new command targets the same address as one or more previously-received command, and therefore, depends thereon. For example, the address associated with the new command may be employed to index one or more of the address collision lists 138, 144. In response, the read and/or write address collision lists 138, 144 may output data indicating previously-received commands which target the same address as the new command (e.g., actual address collision dependency data). The command pipeline logic 110 may employ an arbitrary byte boundary for addresses associated with commands (although full addresses may be employed). For example, a 256-Byte boundary may be employed for such addresses. Therefore, the address collision lists 138, 144 may be indexed on a 256-Byte boundary.

Further, the command pipeline logic 110 may employ the second logic 416 of the barrier command handling logic 133 to pre-calculate a dependency of a new functional memory command on a preceding read and/or write command. When the new functional memory command is associated with its pre-calculated dependency, the pre-calculated dependency may be compared with valid in-flight commands to ensure that the command does not depend on invalid commands.

If the new command is not the first command of its type following a barrier command, the actual address collision dependency data related to the new command may be stored as an entry in one or more of the dependency matrices 154, 164. Alternatively, if the new command is the first command of its type following a barrier command, the pre-calculated dependency data, which may serve as a dummy address collision dependency data, associated with the new command may be stored as an entry in one or more of the dependency matrices 154, 164. More specifically, the barrier command received before the new command may cause the barrier flag to be set in the read and write command control logic 167, 182. Thereafter, the barrier command may be removed from the command execution list, and therefore, will not be saved in a command queue 172, 187, thereby preserving space in the command queue 172, 187. Setting the barrier flag will cause corresponding selection logic 412, 413 to output the pre-calculated dependency data to the corresponding dependency matrix 154, 164.

For example, address collision dependency data or pre-calculated dependency data related to the new read command may be stored in at least the read-write dependency matrix 154. Similarly, if the new command is a write command, address collision dependency data or pre-calculated dependency data related to the new write command may be stored in at least the write-read dependency matrix 164. As described above, the pre-calculated dependency data may be employed if a barrier command is received before (e.g., precedes) the new command. Otherwise, the actual address collision dependency data may be employed. An entry for the new command may be placed in a row 252 of one or more of the dependency matrices 154, 164 corresponding to the tag assigned to the command. Assuming the new read command is assigned Read_Tag 2, the address collision dependency data or pre-calculated dependency data related to the new read command may be stored in the third row of at least the read-write dependency matrix 154.

The new command may be provided to the corresponding address collision dependency list 138, 144 to update such list 138, 144. For example, the new read command may be provided to the read address collision list 144 so that an entry corresponding to the new read command may be added to the list 144. The entry may include the read command and an address associated therewith, and may be indexed by the assigned tag. If the new command is a write command, the write address collision dependency list 138 may be updated in a similar manner.

The new command may be transmitted from the stream splitter logic 132 to the associated queue via corresponding command control logic 167, 182. For example, the new read command may be transmitted from the stream splitter logic 132 to the read command queue 172 via the read command control logic 167. The command pipeline logic 110 may continue to receive new commands and populate the command queues 172, 187 in a similar manner.

The dependency check logic 175, 190 may receive address collision dependency data (e.g., real and dummy address collision dependency data) related to the commands stored in the dependency matrices 154, 164 and determine whether such address collision dependencies have cleared. When all address collision dependencies of a command stored in a queue 172, 187 clear, the command may be issued on the processor bus 114 via its associated interface 178, 193. The command selection logic 450 may be employed to select a pointer 456 from the queue of pointers 406, 407 which serves as a head pointer of the command buffer 402, 404 from which a command is selected to be issued on the processor bus 114. The pointer 456 may be selected based on the address collision dependencies of the new command and validity of commands in one or more of the command buffers 402, 404. For example, the command pipeline logic 110 may issue commands from such queues 172, 187 in FIFO order, as dependencies clear.

In this manner, for example, a write command may be received in the command pipeline logic 110. An address associated with the write command may be employed to update the write address collision list 138. Further, such address may be employed to perform a read address collision list lookup to determine whether the write command has an address collision dependency on a previously-received read command (e.g., actual address collision dependency data). Additionally, the barrier command handling logic 133 may pre-calculate a dependency of the new write command on one or more previously-received functional memory commands. Assuming a barrier command does not precede the write command, the barrier flag in the read and write command control logic 167, 182 is not set. Therefore, the second selection logic 413 may cause the actual address collision dependency data to be stored in the write-read dependency matrix 164. Further, the write command may be stored in write command queue 187, 404 via the write command control logic 182. When the command selection logic 450 determines the write command is valid and is not dependent on any other commands, the command selection logic 450 may issue the write command from the top of the queue 404 onto the bus 114.

Further, assume the command pipeline logic 110 receives a barrier command while the previously-received write command is pending. As described above, the barrier command may force in-order execution of the command preceding the barrier command and a command succeeding the barrier command. The barrier command handling logic 133 may receive the barrier command and set the barrier flag in the read and write command control logic 167, 182. Thereafter, the barrier command may be removed from the execution list.

Additionally, assume the command pipeline logic 110 receives a read command succeeding the barrier command. The read command requires access to an address different than that required by the write command preceding the barrier command. An address associated with the read command may be employed to update the read address collision list 144. Further, such address may be employed to perform a write address collision list lookup to determine whether the read command has an address collision dependency on a previously-received write command (e.g., actual address collision dependency data). Additionally, the barrier command handling logic 133 may pre-calculate a dependency of the new read command on one or more previously-received functional memory commands (e.g., the write command preceding the barrier command). The pre-calculated dependency data may indicate that the new read command depends at least on the write command preceding the barrier command. Because the barrier flag is set, the first selection logic 412 may cause the pre-calculated dependency data related to the read command to be stored in the read-write dependency matrix 154. Such pre-calculated dependency data may serve as dummy address collisions related to the read command. In this manner, when a read and/or write instruction arrive following the barrier command, the pre-calculated dependency may be selected to be stored in one or more dependency matrices 154, 164 rather than actual address collision dependencies output from an address collision dependency list 138, 144. Further, the barrier command handling logic 133 may reset the barrier flags in the read and write command control logic 167, 182.

The read command may be stored in read command queue 402 via the read command control logic 167. Each command may not be issued on the bus 114 until all outstanding dependencies have been cleared. Thus, when the command selection logic 450 determines the read command is valid and is not dependent on any other commands, the command selection logic 450 may issue the read command from the top of the queue 402 onto the bus 114. However, because the read command depends on the write command, the write command will be issued on the bus 114 and executed before the read command. One or more address collision dependencies may be cleared, via the Column Reset command, when an independent command which caused dependencies completes (e.g., completes after being issued on the processor bus 114 via its respective interface 178, 193). For example, when the write command completes, the second dependency check logic 190 may update the address collision dependency data related to the read command stored in at least the read-write dependency matrix 154 such that the read command no longer depends on that write command. Thereafter, the command selection logic 450 may determine the read command is valid and is not dependent on any other commands. Consequently, the command selection logic 450 may issue the read command on the bus 114.

Processing details of a write command followed by a barrier command followed by read command are described above. However, the system 100 may process a different sequence of command in a similar manner. For example, the system 100 may process a write command followed by a barrier command followed by another write command, a read command followed by a barrier command followed by write command, a read command followed by a barrier command followed by another read command, and/or any other sequence of read and/or write commands. In some embodiments, after receiving a new command followed by a barrier command, the command pipeline logic 110 may force the first read and the first write command received after the barrier command to be executed after the new command completes.

Through use of the present methods and apparatus, barrier commands along with address collision dependencies of commands may be employed to tailor issuance of commands on a processor bus 114 to needs of a system 100. More specifically, the present methods and apparatus may implement a barrier instruction on an I/O subsystem by using the address collision dependency matrices 154, 164, 300, 302 which are already in place for command ordering, and pre-calculate dependencies of one or more load/store operations received after the barrier instruction. More specifically, a dependency matrix 154, 164, 300, 302 may normally be used to track dependent and independent load/store instructions using a scoreboarding function and a row set function for setting and a column clear function for clearing address collision dependencies. The present methods and apparatus may employ the same mechanism to force dummy address collision dependencies for one or more commands succeeding the barrier instruction. The pre-calculated dependencies may remove the need to store the barrier instruction in the command queues 172, 187, and thus, reduce additional queuing effects (e.g., a chance a queue 172, 187 becomes full) and improve the utilization of the command queue. More specifically, a dummy address collision dependency may be created (e.g., pre-calculated) for one or more commands received after a barrier command on a command preceding the barrier command.

Commands to be issued on the processor bus 114 may be stalled based on actual and/or dummy address collision dependencies associated with the commands. The command pipeline logic 110 may efficiently force in-order execution of a command preceding a barrier command and one or one more commands received after the barrier command. More specifically, the command pipeline logic 110 does not consume an entry in the read and/or write command queue 172, 187 to store a barrier command. Further, the command pipeline logic 110 does not employ complex pointer manipulation to force such in-order execution, and therefore, does not require logic to implement such pointer manipulation, which reduces space consumed by the command pipeline logic 110 on the first processor 102.

Thus, similar to a conventional I/O processor, the present invention provides an I/O processor 102 which may receive read, write, ensure in-order execution of I/O (EIEIO) and/or similar commands from another processor (e.g., CPU) via an I/O interface. The I/O processor 102 may buffer the commands and master the commands on to a processor bus 114 from which the commands may be passed along to an appropriate device (e.g., PCI-express interface card or DDR2 memory controller). To prevent unnecessary stalls of the write commands while waiting for read commands to complete, the I/O processor may split received commands into separate read and write streams. Because commands are separated in this manner, command order should be maintained between the streams. Depending on interfaces involved and command target address, the ordering rules may range from strict to relaxed. Strict ordering states that the read and write commands must complete in the same order that they are issued from the CPU. Relaxed ordering states that read and write commands can pass each other if they are not targeting the same address space. However, another ordering rule may be employed. The ordering rule is passed along with the command as the command flows from the CPU. Ordering between the read and write streams is maintained using a dependency matrix for each stream and an address look-up list to calculate dependencies. As read and write commands reach the top of their respective queue, a dependency check is performed to see if there are any outstanding dependencies. If there are dependencies then the command and its respective queue is stalled until the dependency is cleared.

In contrast to the conventional I/O processor, the present methods and apparatus may implement a barrier instruction by using dummy address collision dependencies for load/store instructions received subsequent to the barrier instruction. For example, the present methods and apparatus may create dummy address collision dependency for one or more commands received after a barrier command on a command preceding the barrier command. Based on actual and dummy address collision dependencies, the present methods and apparatus may provide a customizable and efficient method of scheduling commands to be issued on a bus.

Software developers may use barrier or fence instructions to force in-order execution of load and store commands sent to an I/O subsystem that may normally operate in an out-of-order execution mode with ordering rules ranging from strict to relaxed. Typically, code that runs within a thread of execution may operate in out-of-order execution mode without suffering from or even noticing the effects of re-ordering. However, when multiple threads of execution (e.g., concurrent programs) are running, the effects of re-ordering may be unpredictable, and therefore, a barrier instruction may be useful to maintain order between threads which target the same address space. In a conventional system, implementing a barrier instruction in an I/O subsystem may consume one or more command queue entries or require the system to include additional space in the command queue to store the barrier instruction and/or may require the system to perform complex pointer manipulation to keep track of the commands ahead of and behind the barrier instruction and to include control logic to perform such pointer manipulation. The present methods and apparatus may implement a barrier instruction in a system without consuming a queue entry to store the barrier instruction, requiring the system to include additional space in the command queue to store the barrier instruction and/or performing complex pointer manipulation.

The foregoing description discloses only exemplary embodiments of the invention. Modifications of the above disclosed apparatus and methods which fall within the scope of the invention will be readily apparent to those of ordinary skill in the art. For instance, although the command pipeline logic 110 includes a read-write dependency matrix 154 and write-read dependency matrix 164, in some embodiments, the command pipeline logic 110 may include a larger number of dependency matrices. For example, the command pipeline logic 110 may also include a read-read dependency matrix 300 and a write-write dependency matrix 302. Thus, in some embodiments, the present methods and apparatus store dependency of read and/or write commands on both current in-flight read and write commands.

Accordingly, while the present invention has been disclosed in connection with exemplary embodiments thereof, it should be understood that other embodiments may fall within the spirit and scope of the invention, as defined by the following claims.

The invention claimed is:

1. A method of issuing a command on a bus of a system, comprising:
receiving a first functional memory command in the system;
receiving a command to force the system to execute functional memory commands in order;
receiving a second functional memory command in the system; and
employing a dependency matrix to indicate the second functional memory command requires access to a same address as the first functional memory command whether or not the second functional memory command actually has an ordering dependency on the first functional memory command;
wherein the dependency matrix is adapted to store data indicating a dependency of a previous command on a prior command.

2. The method of claim 1 further comprising:
setting an in-order execution flag in response to receiving the barrier command to force the system to execute functional memory commands in order; and
generating dummy address collision dependency data indicating the second functional memory command is dependent on the first functional memory command;
wherein employing the dependency matrix to indicate the second functional memory command is dependent on the completion of the first functional memory command includes storing the dummy address collision dependency data in the dependency matrix.

3. The method of claim 2 further comprising:
storing the first functional memory command in a first queue of the system;
removing the command to force the system to execute the functional memory commands in order after setting the in-order execution flag; and
storing the second functional memory command in the first or a second queue.

4. The method of claim 1 further comprising issuing the second functional memory command on the bus after the first functional memory command is executed.

5. The method of claim 4 further comprising, after the first functional memory command is executed, updating data stored in the dependency matrix to indicate that the second functional memory command no longer has an ordering dependency on the first functional memory command.

6. The method of claim 1 wherein the first and second functional memory commands are the same type of command, the first functional memory command is a command of a first type and the second functional memory command is a command of a second type, or the first functional memory command is of the first type and the second functional memory command is of the first or second type.

7. The method of claim 1 further comprising reducing an amount of logic included in the system by employing the dependency matrix to force execution of the first and second functional memory commands in order.

8. An apparatus for issuing a command, comprising:
a bus; and
command pipeline logic coupled to the bus and including a dependency matrix adapted to store data indicating whether a functional memory command received by the command pipeline logic has an ordering dependency on one or more functional memory commands previously received by the command pipeline logic;
wherein the command pipeline logic is adapted to:
receive a first functional memory command;
receive a command to force the command pipeline logic to execute functional memory commands in order;
receive a second functional memory command; and
employ the dependency matrix to indicate the second functional memory command has an ordering dependency on the first functional memory command whether or not the second functional memory command actually has an ordering dependency on the first functional memory command.

9. The apparatus of claim 8 wherein the command pipeline logic is further adapted to:
set an in-order execution flag in response to receiving the command to force the command pipeline logic to execute functional memory commands in order;
generate dummy address collision dependency data indicating the second functional memory command has an ordering dependency on the first functional memory command; and
store the dummy address collision dependency data in the dependency matrix.

10. The apparatus of claim 9 wherein the command pipeline logic is further adapted to:
store the first functional memory command in a first queue of the command pipeline logic;
remove the command to force the command pipeline logic to execute the functional memory commands in order after setting the in-order execution flag; and
store the second functional memory command in the first or a second queue.

11. The apparatus of claim 8 wherein the command pipeline logic is further adapted to issue the second functional memory command on the bus after the first functional memory command is executed.

12. The apparatus of claim 11 wherein the command pipeline logic is further adapted to, after the first functional memory command is executed, update data stored in the dependency matrix to indicate that the second functional memory command no longer has an ordering dependency on the first functional memory command.

13. The apparatus of claim 8 wherein the first and second functional memory commands are the same type of command, the first functional memory command is a command of a first type and the second functional memory command is a command of a second type, or the first functional memory command is of the first type and the second functional memory command is of the first or second type.

14. The apparatus of claim 8 wherein the command pipeline logic is further adapted to reduce an amount of logic included therein by employing the dependency matrix to force execution of the first and second functional memory commands in order.

15. A system for issuing a command, comprising:
a first processor; and
a second processor coupled to the first processor and adapted to communicate with the first processor;
wherein the first processor includes an apparatus for issuing a command, comprising:
a bus; and
command pipeline logic coupled to the bus and including a dependency matrix adapted to store data indicating whether a functional memory command received by the command pipeline logic has an ordering dependency on one or more functional memory commands previously received by the command pipeline logic;
wherein the apparatus is adapted to:
receive a first functional memory command in the system;
receive a command to force the system to execute functional memory commands in order;
receive a second functional memory command in the system; and
employ the dependency matrix to indicate the second functional memory command requires access to the same address as the first functional memory command whether or not the second functional memory command actually has an ordering dependency on the first functional memory command.

16. The system of claim 15 wherein the apparatus is further adapted to:
set an in-order execution flag in response to receiving the command to force the system to execute functional memory commands in order;
generate dummy address collision dependency data indicating the second functional memory command has an ordering dependency on the first functional memory command; and
store the dummy address collision dependency data in the dependency matrix.

17. The system of claim 16 wherein the apparatus is further adapted to:
store the first functional memory command in a first queue of the system;
remove the command to force the system to execute the functional memory commands in order after setting the in-order execution flag; and
store the second functional memory command in the first or a second queue.

18. The system of claim 15 wherein the apparatus is further adapted to issue the second functional memory command on the bus after the first functional memory command is executed.

19. The system of claim 18 wherein the apparatus is further adapted to, after the first functional memory command is executed, update data stored in the dependency matrix to indicate that the second functional memory command no longer has an ordering dependency on the first functional memory command.

20. The system of claim 15 wherein the first and second functional memory commands are the same type of command, the first functional memory command is a command of a first type and the second functional memory command is a command of a second type, or the first functional memory command is of the first type and the second functional memory command is of the first or second type.

21. The system of claim 15 wherein the apparatus is further adapted to reduce an amount of logic included in the system by employing the dependency matrix to force execution of the first and second functional memory commands in order.
